(19) United States
(12) Patent Application Publication
(10) Pub. No.: US 2017/0043509 A1
(43) Pub. Date: Feb. 16, 2017

(54) METHOD OF MANUFACTURING BONDED BODY COMPRISING THREE-DIMENSIONAL NETWORK STRUCTURE AND FOAM

(71) Applicant: Nagase & Co., Ltd., Osaka (JP)

(72) Inventors: Hajime Kitamoto, Tokyo (JP); Takuya Nagase, Hyogo (JP); Takashi Koida, Osaka (JP)

(73) Assignee: Nagase & Co., Ltd., Osaka (JP)

(21) Appl. No.: 15/306,254

(22) PCT Filed: Apr. 14, 2015
(86) PCT No.: PCT/JP2015/061443

§ 371 Date: Oct. 24, 2016

(30) Foreign Application Priority Data
Apr. 22, 2014 (JP) 2014-087954

(51) Int. Cl. B29C 39/10; B01D 69/10; B29C 39/24

(52) U.S. Cl. CPC B29C 39/10; B29C 39/24; B01D 69/105; B29L 2031/755

(57) ABSTRACT

A three-dimensional network structure is impregnated with a foam material through an osmosis membrane. The foam material is then solidified. The foam material with which the three-dimensional network structure is impregnated is in contact with resin wires of the three-dimensional network on a wide area and is solidified. Thus, a bonded body that comprises the three-dimensional network structure and a foam and has improved connection strength can be manufactured.

### TECHNICAL FIELD

An aspect of the present invention relates to a method of manufacturing a bonded body comprising a three-dimensional network structure and a foam.

### BACKGROUND ART

Patent Literature 1 discloses a three-dimensional network structure formed by causing resin wires having elasticity to adhere to each other at adhesion points, the wires being curved and entangled with each other. Such a three-dimensional network structure has excellent characteristics as a cushioning material. Furthermore, such a three-dimensional network structure is excellent in breathability.

### CITATION LIST

### Patent Literature

[Patent Literature 1] Japanese Unexamined Patent Publication No. H7-60861

### SUMMARY OF INVENTION

### Technical Problem

Incidentally, cushioning materials include foam formed by foaming and solidifying liquid foam material. To utilize the characteristics of the three-dimensional network structure and the foam industrially, it is required to manufacture a bonded body comprising the three-dimensional network structure and the foam. However, adhesion through use of adhesive or double-sided adhesive tape is insufficient in connection strength between the three-dimensional network structure and the foam. It is thus required to improve the connection strength between the three-dimensional network structure and the foam.

An aspect of the present invention has been made in consideration of the problems. It is thus desired to manufacture a bonded body that comprises a three-dimensional network structure and foam and has improved connection strength.

### Solution to Problem

An aspect of the present invention is a method of manufacturing a bonded body comprising a three-dimensional network structure and a foam, comprising: a step of disposing the three-dimensional network structure formed by three-dimensionally combining resin wires, and a foam material; a step of impregnating the three-dimensional network structure with the foam material; and a step of solidifying the foam material.

According to this configuration, the three-dimensional network structure is impregnated with the foam material. The foam material can then be solidified. The foam material with which the three-dimensional network structure is impregnated is in contact with wires of the three-dimensional network structure on a wide area and is solidified. Thus, the bonded body that comprises the three-dimensional network structure and the foam and has improved connection strength can be manufactured.

In this case, the method further comprises a step of disposing an osmosis membrane through which the foam material is permeable, on an external surface of the three-dimensional network structure, before the step of disposing the three-dimensional network structure and the foam material. In the step of impregnating the three-dimensional network structure with the foam material, the three-dimensional network structure can be impregnated with the foam material through the osmosis membrane.

According to this configuration, the three-dimensional network structure can be impregnated with the foam material through the osmosis membrane. Consequently, adjustment of the permeable amount of the foam material through the osmosis membrane can adjust the width of the impregnated section formed by impregnating the three-dimensional network structure with the foam material and subsequently solidifying the foam material.

Furthermore, the osmosis membrane can be cloth formed of fibers, and the fibers forming the cloth can be covered with resin not to expose surfaces of the fibers.

According to this configuration, the osmosis membranes are cloth formed of fibers. The fibers that form the cloth are covered with the resin not to expose the surface of the fibers. Thus, when the three-dimensional network structure is impregnated with the foam material through the osmosis membrane, it is difficult to eliminate the bubbles of the foam material because of the unevenness of the fibers. Consequently, elimination of the bubbles of the foam material can prevent the portion of the three-dimensional network structure impregnated with the foam material from being hardened.

The osmosis membrane can be nonwoven fabric formed of monofilament fibers.

According to this configuration, the osmosis membrane is nonwoven fabric formed of monofilament fibers. The monofilament fibers do not have unevenness on the surface the multifilaments have. The nonwoven fabric has a smaller amount of unevenness at portions into which the foam material permeates than woven fabric. Thus, when the three-dimensional network structure is impregnated with the foam material through the osmosis membrane, it is difficult to eliminate the bubbles of the foam material because of the unevenness of the fibers. Consequently, elimination of the bubbles of the foam material can prevent the portion of the three-dimensional network structure impregnated with the foam material from being hardened.

The osmosis membrane can be a resin film having any of pores or slits.

According to this configuration, the osmosis membrane is a resin film having any of pores or slits. The resin film does not have unevenness due to fibers as in the case of woven fabric. Thus, when the three-dimensional network structure is impregnated with the foam material through the osmosis membrane, the bubbles of the foam material is not eliminated because of the unevenness of the fibers. Consequently, elimination of the bubbles of the foam material can prevent the portion of the three-dimensional network structure impregnated with the foam material from being hardened.

The osmosis membrane can be a resin film having a plurality of slits bent at respective tops, and a pair of the slits among the plurality of the slits can be bent in directions opposite to each other, and can be disposed to cause the tops to face each other.

According to this configuration, the slits whose tops are bent at the pair of tops facing each other allow the foam material to permeate in the directions of the other slits. Consequently, even if the amount of foam material permeating from the pair of slits having the tops facing each other is small, the material tends to be bonded to the foam material permeating from other slits. Consequently, higher connection strength can be achieved by a smaller amount of impregnation.

The osmosis membrane can be a resin film having a plurality of slits bent at respective tops, and a pair of the slits among the plurality of the slits can be bent in a same direction, and can be disposed to cause the tops to be oriented in a same direction.

According to this configuration, the slits whose tops are bent at the pair of tops oriented in the same direction allow the foam material to permeate in the same direction. Consequently, the foam material permeating from the slits with the pair of tops oriented in the same direction tends to be easily solidified at a smaller distance from the osmosis membrane. Consequently, higher connection strength can be achieved by a smaller amount of impregnation.

The method further comprises a step of disposing an impregnation prevention membrane through which the foam material is impermeable, in an inside of the three-dimensional network structure, before the step of disposing the three-dimensional network structure and the foam material. In the step of impregnating the three-dimensional network structure with the foam material, a site of the three-dimensional network structure that is not configured to be impermeable by the impregnation prevention membrane can be impregnated with the foam material.

According to this configuration, the impregnation prevention membrane makes the foam material impermeable, and a site of the three-dimensional network structure that is not configured to be impermeable by the impregnation prevention membrane is impregnated with the foam material, and subsequently the foam material is solidified to connect the three-dimensional network structure and the foam to each other. Consequently, adjusting the arrangement of the impregnation prevention membrane can adjust the width of the impregnated section formed by impregnating the three-dimensional network structure with the foam material and subsequently solidifying the foam material.

The method further comprises a part of the three-dimensional network structure that includes a low hardness section having a lower hardness than portions other than the part of the three-dimensional network structure. In the step of impregnating the three-dimensional network structure with the foam material, the low hardness section can be impregnated with the foam material.

According to this configuration, the part of the three-dimensional network structure has a low hardness section having lower hardness than the portions other than the part of the three-dimensional network structure. The low hardness section is impregnated with the foam material. Consequently, the difference between the hardness of the impregnated section formed by impregnating the three-dimensional network structure with the foam material and subsequently by solidifying the foam material and the hardness of the three-dimensional network structure and the foam can be reduced.

### Advantageous Effects of Invention

According to the method of manufacturing a bonded body comprising a three-dimensional network structure and foam in an aspect of the present invention, the bonded body comprising the three-dimensional network structure and foam with improved connection strength can be manufactured.

### BRIEF DESCRIPTION OF DRAWINGS

FIG. 1 is a perspective view showing a three-dimensional network structure of a first embodiment.

FIG. 2 is an enlarged view of the three-dimensional network structure of FIG. 1.

FIG. 3 is a perspective view showing a state where an osmosis membrane is disposed on an external surface of the three-dimensional network structure.

FIG. 4 is an enlarged view of the osmosis membrane in FIG. 3.

FIG. 5 is an enlarged view showing an example of osmosis membrane having smaller cavities than the osmosis membrane in FIG. 4 has.

FIG. 6 is an enlarged view showing an example of osmosis membrane made of nonwoven fabric formed of monofilament fibers.

FIG. 7 is an enlarged view showing an example of osmosis membrane made of a resin film that has foam-material permeable pores.

FIG. 8 is an enlarged view showing an example of osmosis membrane made of a resin film that has foam-material permeable slits.

FIG. 9 is an enlarged view showing an example of osmosis membrane made of a resin film that has a plurality of bent slits allowing the foam material to permeate in directions of facing each other.

FIG. 10 is an enlarged view showing an example of osmosis membrane made of a resin film that has a plurality of curved slits allowing the foam material to permeate in directions of facing each other.

FIG. 11 is an enlarged view showing an example of osmosis membrane made of a resin film that has a plurality of bent slits allowing the foam material to permeate in the same direction.

FIG. 12 is an enlarged view showing an example of osmosis membrane made of a resin film that has a plurality of curved slits allowing the foam material to permeate in the same direction.

FIG. 13 is a perspective view showing a state where the three-dimensional network structure in FIG. 3 on which the osmosis membrane is disposed is put in a mold.

FIG. 14 is a perspective view showing a state where liquid foam material is put in a mold to be adjacent to the osmosis membrane in FIG. 13.

FIG. 15 is a perspective view showing a state where the three-dimensional network structure is impregnated with the foam material through the osmosis membrane in FIG. 14.

FIG. 16 is a diagram showing a state where the foam material permeates the osmosis membrane made of the resin film having the slits shown in FIG. 9.

FIG. 17 is a diagram showing a state where the foam material permeates the osmosis membrane made of the resin film having the slits shown in FIG. 11.

FIG. 18 is a perspective view showing a bonded body comprising the three-dimensional network structure and the foam after the foam material in FIG. 15 is solidified.

FIG. 19 is a perspective view showing a mode where an impregnation prevention membrane is formed in the three-dimensional network structure by trickling down a gel material for prevention membrane from a nozzle into the three-dimensional network structure in a second embodiment.

FIG. 20 is a perspective view showing a mode where an impregnation prevention membrane is formed in the three-dimensional network structure by immerging the three-dimensional network structure with photo-curable solution and by irradiating the solution surface with light in a third embodiment.

FIG. 21 is a perspective view showing a three-dimensional network structure where a low hardness section is formed in a fourth embodiment.

FIG. 22 is a diagram showing a mode where the amount of impregnation is controlled by changing the distance between the positions on which the three-dimensional network structure and the foam material are disposed in a fifth embodiment.

FIG. 23 is a diagram showing a mode where the amount of impregnation is controlled by changing the height of a protrusion provided between the three-dimensional network structure and the foam Material in a sixth embodiment.

FIG. 24 is a graph that shows the hardness of the impregnated section with respect to various types of osmosis membranes.

### DESCRIPTION OF EMBODIMENTS

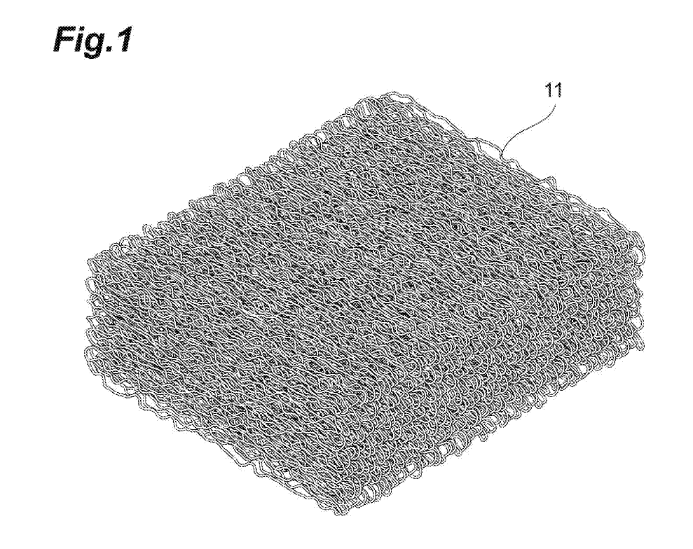

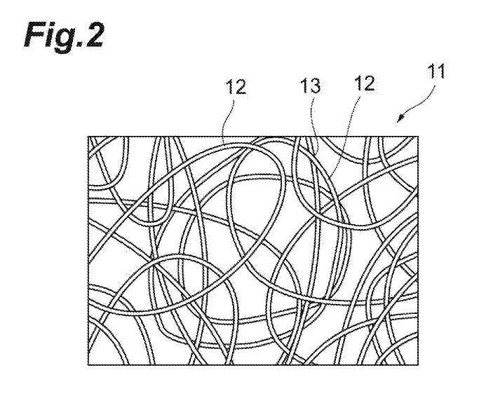

Hereinafter, referring to the drawings, a method of manufacturing a bonded body comprising a three-dimensional network structure and foam according to an embodiment of the present invention is described in detail. As shown in FIGS. 1 and 2, a three-dimensional network structure 11 of a first embodiment is formed by three-dimensionally combining resin wires 12. More specifically, the three-dimensional network structure 11 is formed by causing the plurality of resin wires 12 having elasticity to adhere to each other at a plurality of adhesion points 13, the wires being curved and entangled with each other. The resin wire 12 is formed of a thermoplastic resin. The thermoplastic resin may be any of polyolefins, such as polyethylene and polypropylene, polyester polymer, polyester elastomer, and polyurethane polymer.

The outer diameter of the resin wire 12 may range from 0.1 to 7 mm. The resin wire 12 may be hollow wire with an empty inside. The rate of hollowness of the resin wire 12 may range from 5 to 80%. When the three-dimensional network structure 11 is formed of the resin wires 12, the thermoplastic resin is melt by an extruder. The melt thermoplastic resin is ejected as the resin wires 12 from nozzles and caused to fall freely. The plurality of resin wires 12 that are still in a melt state are caused to adhere to each other at the plurality of adhesion points 13. The adhering resin wires 12 are solidified, which can manufacture the three-dimensional network structure 11.

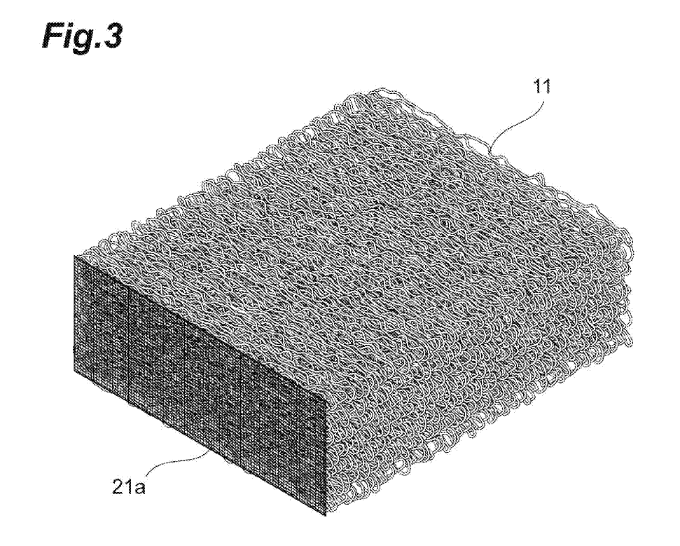

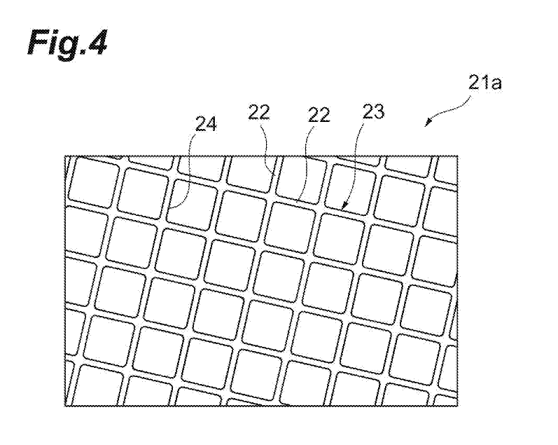

As shown in FIG. 3, a foam-material permeable osmosis membrane 21a is disposed on the external surface of the three-dimensional network structure 11. As shown in FIG. 4, the osmosis membrane 21a is cloth formed by being woven with fibers 22. The fibers 22 of the osmosis membrane 21a are covered with a resin cover 23 made of resin, such as vinyl chloride, not to expose the surface. Cavities 24 through which the foam material is permeable reside between the fibers 22 and the fibers 22. For example, a nonslip sheet or the like made of foaming vinyl chloride or the like is applicable as the osmosis membrane 22a.

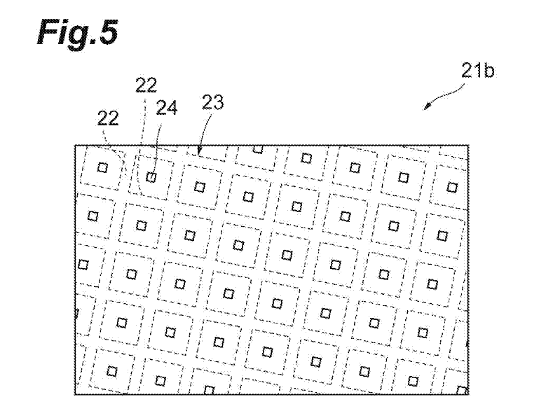

To adjust the amount of impregnation with the foam material into the three-dimensional network structure 11, the amount of foam material with which the osmosis membrane 21a is impregnated per unit time is appropriately adjusted. For example, to adjust the amount of impregnation with the foam material into the three-dimensional network structure 11, a plurality of osmosis membranes 21a may be disposed in a stacked manner on the external surface of the three-dimensional network structure 11. By changing the sizes of the cavities 24 of the osmosis membrane 22a, the amount of foam material passing through the osmosis membrane 21a per unit time can be adjusted. For example, as with an osmosis membrane 21b shown in FIG. 5, increase in the amount of resin cover 23 that covers the fibers 22 can manufacture the osmosis membrane 21b having smaller sizes of the cavities 24.

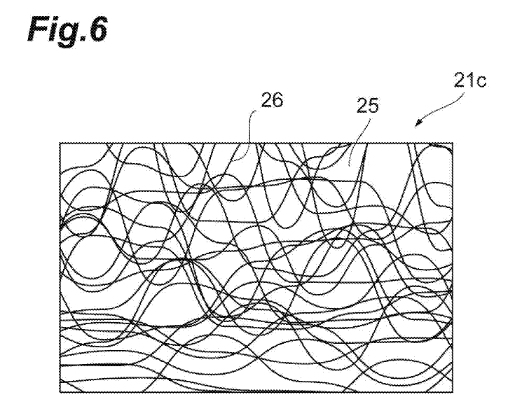

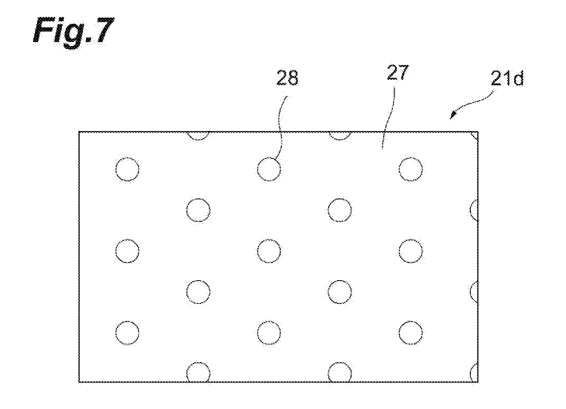

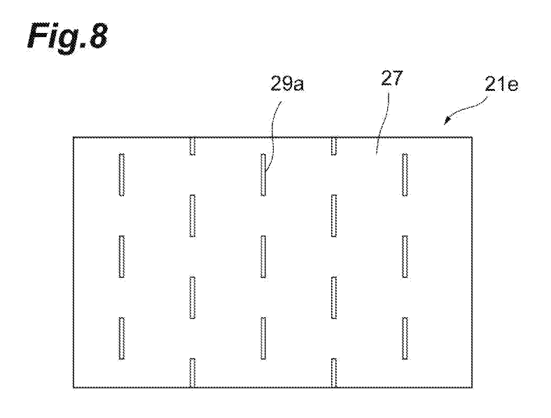

In this embodiment, as shown in FIG. 6, instead of the osmosis membrane 21a, an osmosis membrane 21c that is nonwoven fabric 25 formed of monofilament fibers 26 is applicable. In this embodiment, as shown in FIG. 7, instead of the osmosis membrane 21a, an osmosis membrane 21d that is a resin film 27 having foam-material permeable pores 28 is applicable. In this embodiment, as shown in FIG. 8, instead of the osmosis membrane 21a, an osmosis membrane 21e that is a resin film 27 having foam-material permeable slits 29a is applicable.

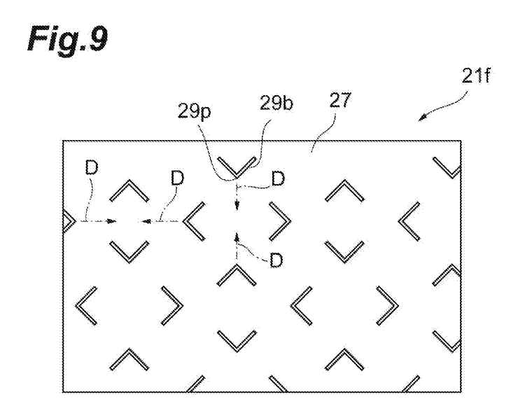

As shown in FIG. 9, instead of the osmosis membrane 21a, an osmosis membrane 21f that is a resin film 27 with slits 29b each being bent at a top 29p on the surface of the resin film 27 is applicable. Each pair of slits 29b bent in directions opposite to each other on the resin film 27 are disposed so that the tops 29p face each other. As described later, the slits 29b with the tops 29p facing each other allow the foam material to permeate in directions D. Thus, even if the amount of foam material permeating through the pair of slits 29b having the tops 29p facing each other is small, the material tends to be easily bonded to the foam material permeating through other slits 29b.

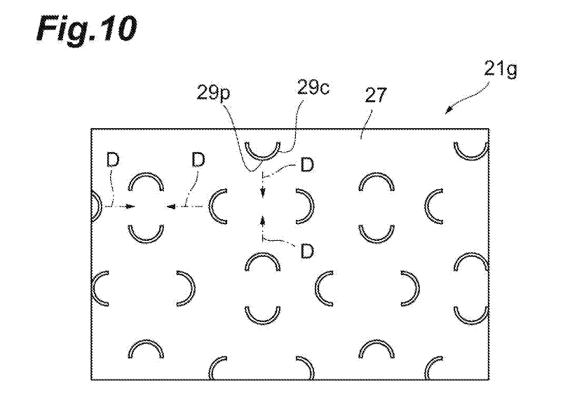

Alternatively, as shown in FIG. 10, instead of the osmosis membrane 21a, an osmosis membrane 21g that is a resin film 27 with slits 29c each being curved at a top 29p on the surface of the resin film 27 is applicable. Each pair of slits 29c curved in directions opposite to each other on the resin film 27 is disposed so that the tops 29p face each other. The osmosis membrane 21g having the curved slits 29c operates in a manner analogous to that of the osmosis membrane 21f.

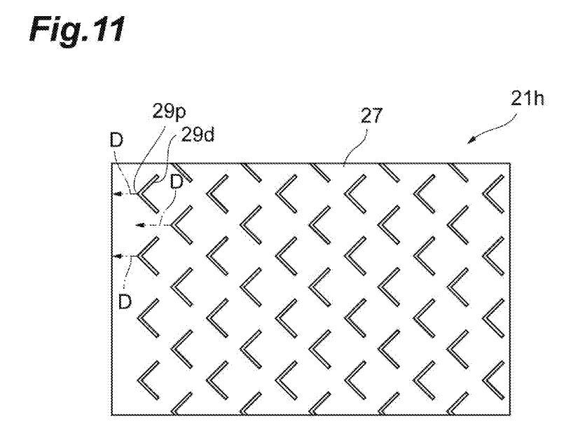

As shown in FIG. 11, instead of the osmosis membrane 21a, an osmosis membrane 21h that is a resin film 27 with slits 29d each being bent at a top 29p on the surface of the resin film 27 is applicable. Each pair of slits 29d bent in the same direction on the resin film 27 is disposed to orient tops 29p in the same direction. As described later, the pair of slits 29d with the tops 29p oriented in the same direction allow the foam material to permeate in the same direction D. Consequently, the foam material permeating through the slits 29d with the pair of tops 29p oriented in the same direction tends to be easily solidified at a smaller distance from the osmosis membrane 21h.

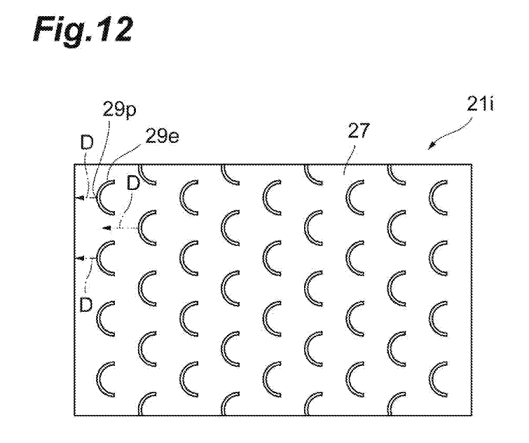

Alternatively, as shown in FIG. 12, instead of the osmosis membrane 21a, an osmosis membrane 21i that is a resin film 27 with slits 29e each being curved at a top 29p on the surface of the resin film 27 is applicable. Each pair of slits 29e curved in the same direction on the resin film 27 is disposed to orient tops 29p in the same direction. The osmosis membrane 21i having the curved slits 29e operates in a manner analogous to that of the osmosis membrane 21h.

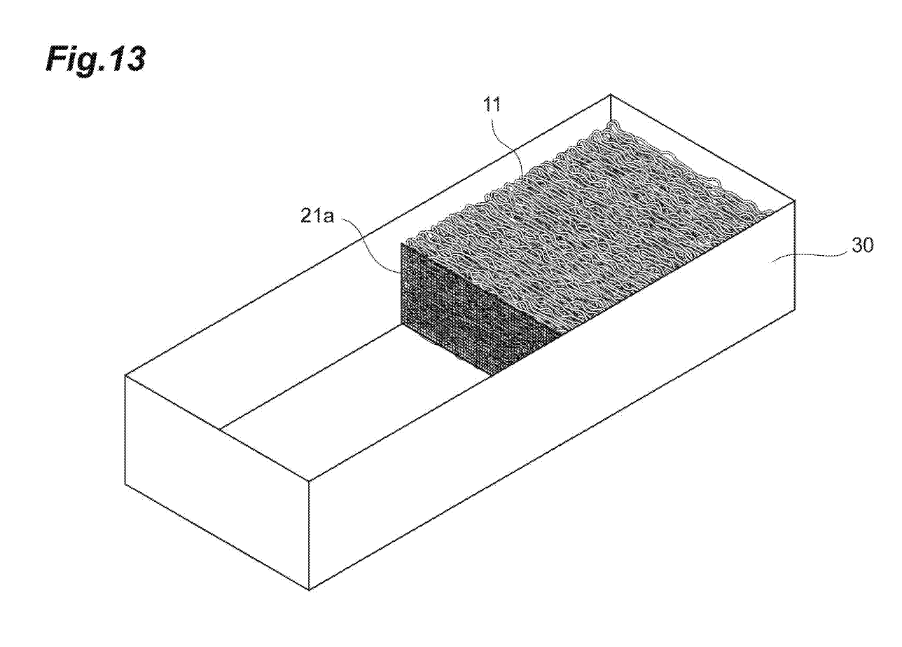

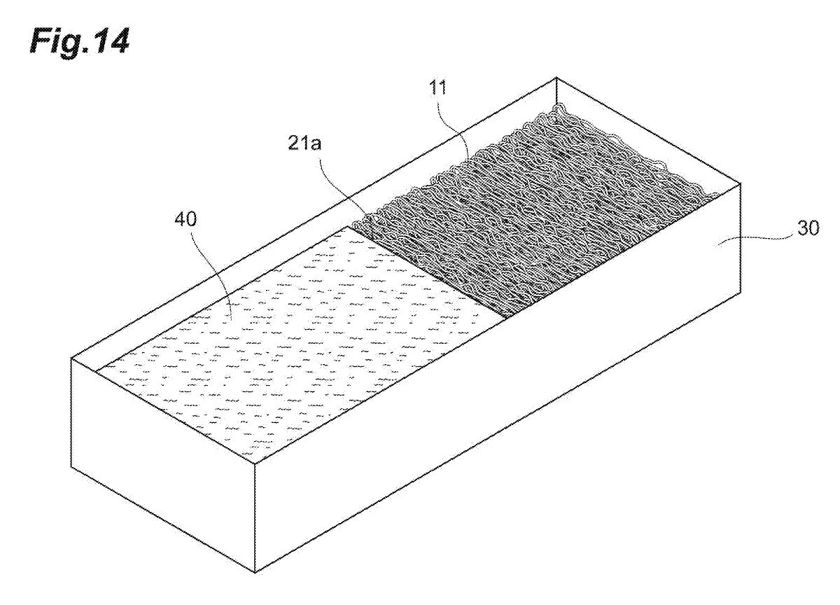

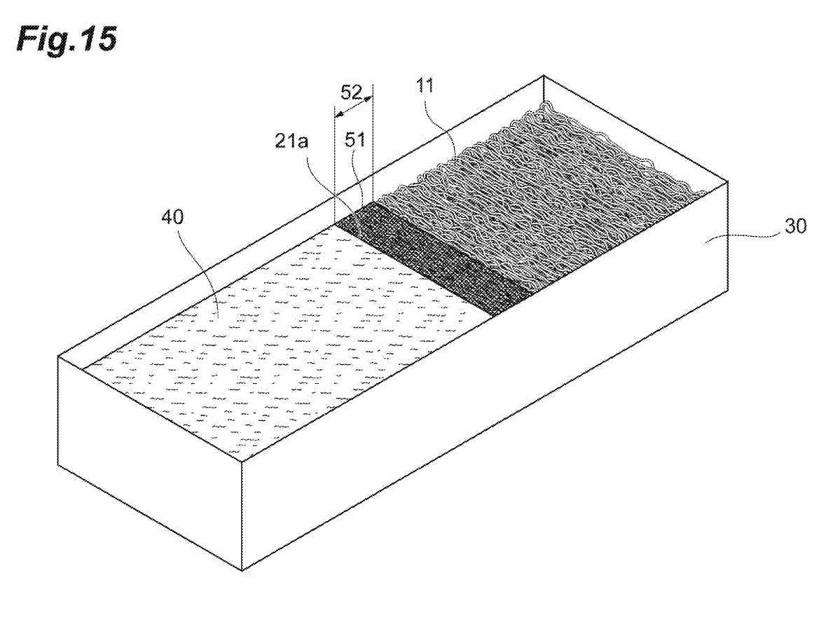

As shown in FIG. 13, the three-dimensional network structure 11 with the external surface on which the osmosis membrane 21a is disposed is put in a mold 30. As shown in FIG. 14, a liquid foam material 40 that is formed into the foam through foaming and being solidified is put into the mold 30. Thus, the liquid foam material 40 is disposed to be adjacent to the osmosis membrane 21a. As shown in FIG. 15, the three-dimensional network structure 11 is impregnated with a part of the foam material 40 through the osmosis membrane 21a. The impregnated section 51 having an amount of impregnation 52 in conformity with the number of stacks of the osmosis membranes 21a or the sizes of the cavities 24 is formed. In this embodiment, the three-dimensional network structure 11 may be impregnated with the entire foam material 40.

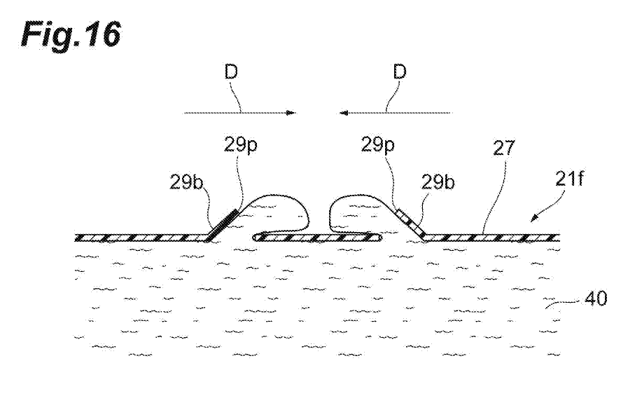

Here, in the case of use of the osmosis membrane 21f made of the resin film 27 having the slits 29b bent at the tops 29p as shown in FIG. 9 instead of the osmosis membrane 21a, the slits 29b facing each other at the tops 29p causes the foam material to permeate in the direction D as shown in FIG. 16. Thus, even if the amount of foam material permeating through the pair of slits 29b having the tops 29p facing each other is small, the material tends to be easily bonded to the foam material permeating through other slits 29b. Consequently, higher connection strength can be achieved by a smaller amount of impregnation 52.

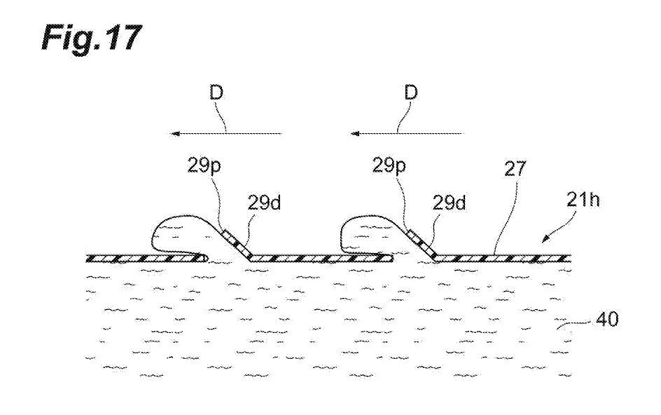

Alternatively, in the case of use of the osmosis membrane 21h of the resin film 27 having the slits 29d bent at the tops 29p as shown in FIG. 11 instead of the osmosis membrane 21a, the slits 29d oriented in the same direction at the tops 29p causes the foam material to permeate in the same direction D as shown in FIG. 17. Consequently, the foam material permeating from the slits 29d with the pair of tops 29p oriented in the same direction tends to be solidified at a smaller distance from the osmosis membrane 21h. Consequently, higher connection strength can be achieved by a smaller amount of impregnation 52.

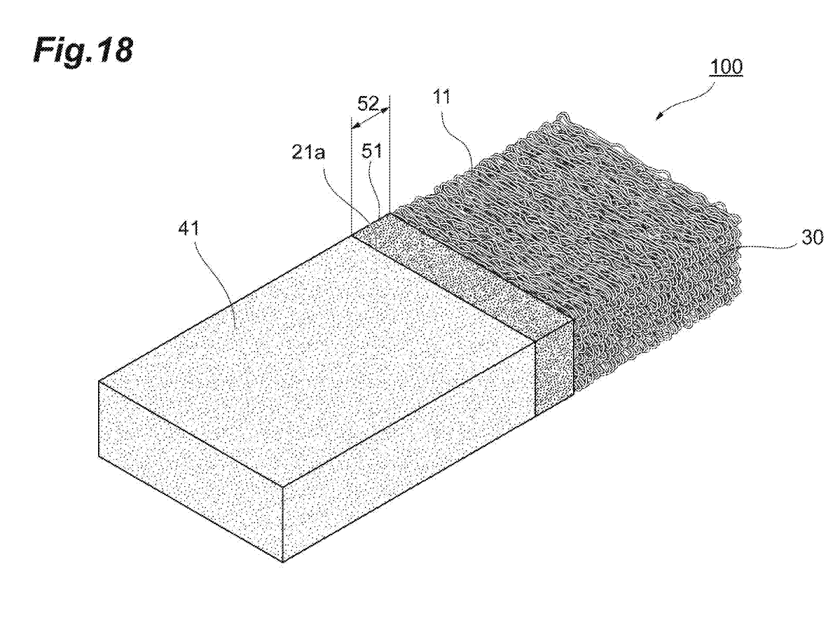

As shown in FIG. 18, the foam material 40 is solidified to form the foam 41. The foam material 40 with which the impregnated section 51 of the three-dimensional network structure 11 is impregnated is solidified to thereby connect the three-dimensional network structure 11 and the foam 41 to each other. A bonded body 100 where the three-dimensional network structure 11 and the foam 41 are connected to each other is taken out from the mold 30.

According to this embodiment, the three-dimensional network structure 11 is impregnated with the foam material 40 through the osmosis membrane 21a. Furthermore, the foam material 40 is solidified. The foam material 40 with which the three-dimensional network structure 11 is impregnated is in contact with the resin wires 12 of the three-dimensional network structure 11 on a wide area and is solidified. Thus, the bonded body 100 that comprises the three-dimensional network structure 11 and the foam 41 and has improved connection strength can be manufactured.

According to this embodiment, the foam material 40 is disposed to be adjacent to the osmosis membrane 21a, and the three-dimensional network structure 11 is impregnated with the foam material 40 through the osmosis membrane 21a. Consequently, adjustment of the permeable amount of the foam material 40 through the osmosis membrane 21a can adjust the width of the impregnated section 51 formed by impregnating the three-dimensional network structure 11 with the foam material 40 and subsequently solidifying the foam material 40.

According to this embodiment, the osmosis membrane 21a is cloth formed of fibers 22. The fibers 22 that form the cloth are covered with the resin cover 23 not to expose the surface of the fibers 22. Thus, when the three-dimensional network structure 11 is impregnated with the foam material 40 through the osmosis membrane 21a, it is difficult to eliminate the bubbles of the foam material 40 because of the unevenness of the fibers 22. Consequently, elimination of the bubbles of the foam material 40 can prevent the impregnated section 51 of the three-dimensional network structure 11 impregnated with the foam material 40 from being hardened. In this case, as with the osmosis membrane 21b, the amount of impregnation 52 can be reduced by reducing the sizes of the cavities 24.

Alternatively, in this embodiment, the osmosis membrane 21c is nonwoven fabric 25 formed of monofilament fibers 26. The monofilament fibers 26 do not have unevenness on the surface the multifilaments have. The nonwoven fabric 25 has a smaller amount of unevenness at portions into which the foam material 40 permeates than woven fabric. Thus, when the three-dimensional network structure 11 is impregnated with the foam material 40 through the osmosis membrane 21c, it is difficult to eliminate the bubbles of the foam material 40 because of the unevenness of the fibers. Consequently, elimination of the bubbles of the foam material 40 can prevent the impregnated section 51 of the three-dimensional network structure 11 impregnated with the foam material 40 from being hardened.

Alternatively, in this embodiment, the osmosis membrane 21d is a resin film 27 having pores 28. An osmosis membrane 21e is a resin film 27 having slits 29. The resin film 27 does not have unevenness due to fibers as in the case of woven fabric. Thus, when the three-dimensional network structure 11 is impregnated with the foam material 40 through the osmosis membranes 21c and 21d, the bubbles of the foam material 40 is not eliminated because of the unevenness of the fibers. Consequently, elimination of the bubbles of the foam material 40 can prevent the impregnated section 51 of the three-dimensional network structure 11 impregnated with the foam material 40 from being hardened in comparison with the other portions.

In addition, the osmosis membrane 21f is the resin film 27 having slits 29b bent at the tops 29p on the surface thereof. Each pair of slits 29b bent in directions different from each other on the resin film 27 is disposed so that the tops 29p face each other. Consequently, even if the amount of foam material permeating through the pair of slits 29b having the tops 29p facing each other is small, the material tends to be easily bonded to the foam material permeating from other slits 29b. Consequently, higher connection strength can be achieved by a smaller amount of impregnation 52. The osmosis membrane 21g that is the resin film 27 having the slits 29c curved at the tops 29p on the surface thereof exerts advantageous effects analogous to those of the osmosis membrane 21g.

Alternatively, the osmosis membrane 21h is the resin film 27 having slits 29b bent at the tops 29p on the surface thereof. Each pair of slits 29d bent in the same direction on the resin film 27 is disposed to orient tops 29p in the same direction. Consequently, the foam material permeating through the slits 29d with the pair of tops 29p oriented in the same direction tends to be easily solidified at a smaller distance from the osmosis membrane 21h. Consequently, higher connection strength can be achieved by a smaller amount of impregnation 52. The osmosis membrane 21i that is the resin film 27 having the slits 29e curved at the tops 29p on the surface thereof also exerts advantageous effects analogous to those of the osmosis membrane 21h.

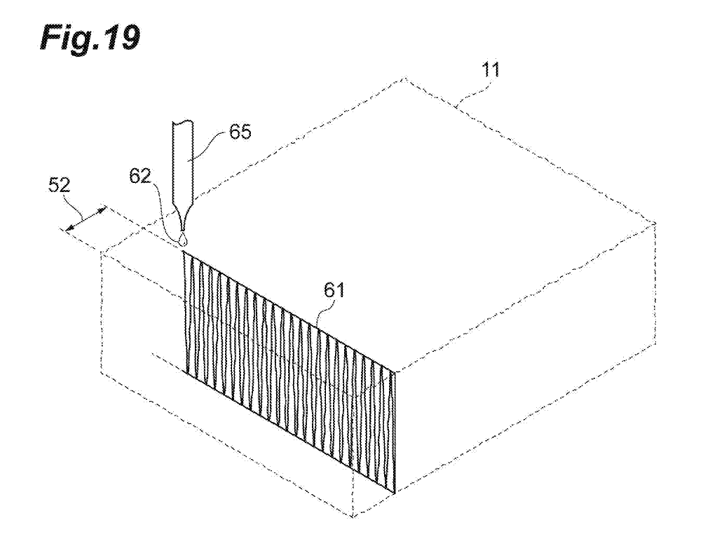

A second embodiment of the present invention is hereinafter described. In the first embodiment, the amount of impregnation 52 is set by setting the amounts of the foam materials 40 permeating the respective osmosis membranes 21a to the 21i. As shown in FIG. 19, in this embodiment, the amount of impregnation 52 is set by forming an impregnation prevention membrane 61 through which the foam material 40 cannot permeate the three-dimensional network structure 11. At the end of a desired impregnated section 51 in the three-dimensional network structure 11, gel material 62 for prevention membrane that has been adjusted to have a freely selected viscosity trickles down from a nozzle 65. The gel material 62 for prevention membrane may be any of thermoreversible elastomer, volatile gel, photocurable resin, and the like. In the step of impregnating the three-dimensional network structure 11 with the foam material 40, a site of the three-dimensional network structure 11 that is not configured to be impermeable by the impregnation prevention membrane 61 is impregnated with the foam material 40. At the position corresponding to the amount of impregnation 52 that is the requisite minimum for connecting the foam 41 to the three-dimensional network structure 11, the impregnation prevention membrane 61 to which the foam material 40 is impermeable is formed, thereby exerting advantageous effects analogous to those in the case of disposing the osmosis membranes 21a to 21i in the first embodiment.

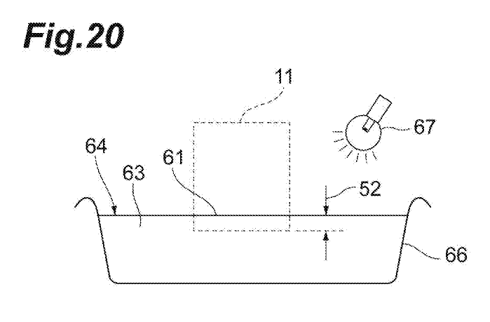

A third embodiment of the present invention is hereinafter described. In this embodiment, as shown in FIG. 20, the three-dimensional network structure 11 is immerged in photo-curable solution 63 in a solution bath 66 to the depth of a desired amount of impregnation 52. In a state where the three-dimensional network structure 11 is immerged in the photo-curable solution 63, the solution surface 64 is irradiated with light from a light source 67, thereby curing only the solution surface 64. Consequently, in the three-dimensional network structure 11, the impregnation prevention membrane 61 can be formed. Alternatively, the three-dimensional network structure 11 may be immerged to the desired depth of the amount of impregnation 52 in calcium lactate aqueous solution instead of the photo-curable solution 63, and the surface of the calcium lactate aqueous solution may be sprayed with sodium alginate aqueous solution or the like, thereby also allowing the impregnation prevention membrane 61 to be formed in the three-dimensional network structure 11.

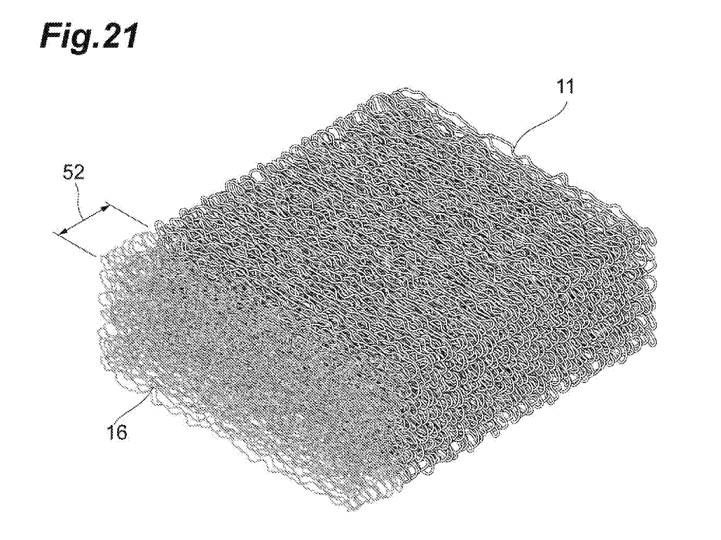

A fourth embodiment of the present invention is hereinafter described. As indicated by experimental examples described later, the hardness of the impregnated section 51 is allowed to be higher than the sum of the hardness of the three-dimensional network structure 11 and the hardness of the foam 41 because the parts of network resin of the three-dimensional network structure 11 are cross-linked by the foam 41. To reduce the difference between the hardness of the impregnated section 51 and the hardness of the three-dimensional network structure 11 and the foam 41, a low hardness section 16 having a lower hardness than the entire hardness of the three-dimensional network structure 11 can be formed at a part of the three-dimensional network structure 11, as shown in FIG. 21. In the step of disposing the foam material 40, the foam material 40 is disposed to be adjacent to the low hardness section 16. In the step of impregnating the three-dimensional network structure 11 with the foam material 40, the low hardness section 16 is impregnated with the foam material 40.

The low hardness section 16 can be formed by changing the nozzle to be used for molding at the part of the low hardness section 16 and reducing the diameter of the resin wire ejected from the nozzle while the three-dimensional network structure 11 is manufactured. In the case where the three-dimensional network structure 11 is manufactured as a whole by ejecting hollow resin wires from nozzles used for molding, the nozzles used for molding are changed at the part of the low hardness section 16, and resin wires that are not hollow and have smaller diameters than parts other than the low hardness section 16 are ejected, which can form the low hardness section 16.

The material for the three-dimensional network structure 11 is the same as that for the low hardness section 16 and that for parts other than the low hardness section 16. Consequently, the connection force between the three-dimensional network structure 11 and the foam 41 is not reduced. By making the low hardness section 16 as the impregnated section 51, the difference between the hardness of the impregnated section 51 and the hardness of the three-dimensional network structure 11 and the foam 41 can be reduced.

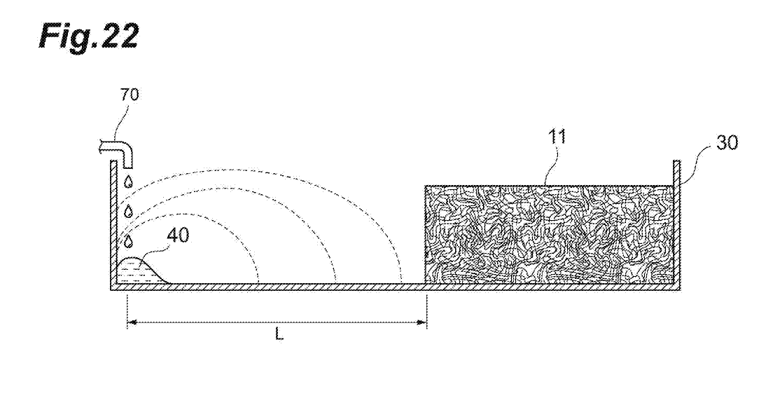

A fifth embodiment of the present invention is hereinafter described. As shown in FIG. 22, in this embodiment, without use of the osmosis membranes 21a to 21i in the first embodiment and the impregnation prevention membrane 61 in the second and third embodiments, the arrangement distance L between the three-dimensional network structure 11 and the foam material 40 is changed to control the amount of impregnation 52. For example, the position where the foam material 40 is discharged from the nozzle 70 into the mold 30 is configured to a position farthest from the three-dimensional network structure 11 in the upper mold 30. Thus, as indicated by broken lines in FIG. 22, the surface viscosity of the foam material 40 in a process of foaming is increased before the material reaches the three-dimensional network structure 11, thereby allowing the amount of impregnation 52 to be controlled to be constant and to the minimum. The manufacturing method of this embodiment is also applicable to cases of using the osmosis membranes 21a to 21i in the first embodiment.

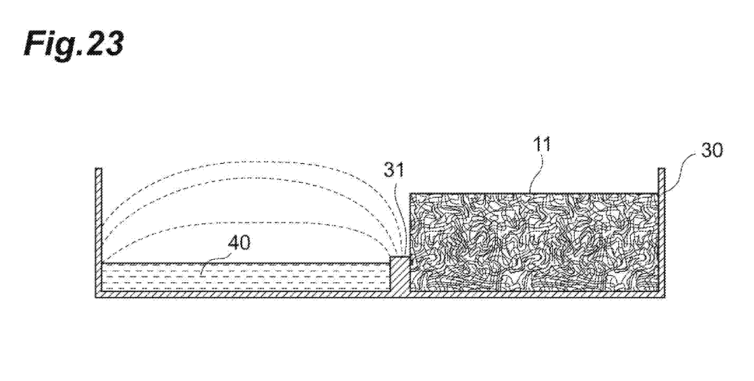

A sixth embodiment of the present invention is hereinafter described. As shown in FIG. 23, in this embodiment, without use of the osmosis membranes 21a to 21i in the first embodiment and the impregnation prevention membrane 61 in the second and third embodiments, the height of a rib 31 that is a protrusion provided between the three-dimensional network structure 11 and the foam material 40 in the mold 30 is changed to control the amount of impregnation 52. The rib 31 is in contact with the lower end of the three-dimensional network structure 11 in the mold 30 and supports this structure. The height from the lower end of the three-dimensional network structure 11 to the upper end of the rib 31 is configured to range from 1 to 50 mm. The rib 31 prevents the foam material 40 having not foamed yet from flowing into the three-dimensional network structure 11.

As indicated by broken lines in FIG. 23, the foam material 40 is prevented from foaming in the horizontal direction to progress foaming in the vertical direction before the three-dimensional network structure ills impregnated, and after the space in the mold 30 is filled, the three-dimensional network structure 11 is impregnated with a residual amount of foam, thereby allowing the amount of impregnation 52 to be controlled to be constant and to the minimum only through adjustment of the amount of charge of the foam material 40. The manufacturing method of this embodiment is also applicable to cases of using the osmosis membranes 21a to 21i in the first embodiment.

### Experimental Example

Hereinafter, an experimental example of the first embodiment is described. A tension was applied to the bonded body 100 comprising the three-dimensional network structure 11 and the foam 41 as shown in FIG. 18 in a direction perpendicular to the osmosis membrane 21a as a bonded section. Gradual increase in tension broke the part of the foam 41 as a base material. No rupture occurred in parts at the osmosis membrane 21a as the bonded section and the impregnated section 51.

The hardness of the impregnated section 51 was measured in a case where the bonded body 100 was manufactured with application of the osmosis membranes 21a and 21c and in a case where the bonded body 100 was manufactured with application of another type of the osmosis membrane instead of the osmosis membranes 21a and 21c. The types of osmosis membranes shown in the following Table 1 were applied as the osmosis membranes. As to each of the manufactured bonded bodies 100, a load is applied to the impregnated section 51 in a direction parallel to the osmosis membrane and perpendicular to the external surface of the three-dimensional network structure 11. The load in the case of deformation of the impregnated section 51 by 10 mm was measured as the hardness of the impregnated section 51.

TABLE 1

| | | | Amount | Impreg- | |
|---|---|---|---|---|---|
| | | | of | nated | Normal |
| | Density | | impreg- | section | part |
| Osmosis | or | | nation | hardness | hardness |
| membrane | material | Material | (mm) | (N) | (N) |
| Nonwoven | 100 g/m² | Polyester | 1 | 80.4 | |
| fabric A | | | | | |
| Nonwoven | | Polyester | 12 | 68.4 | |
| fabric B | | | | | |
| Nonwoven | 40 g/m² | Polyester | 15 | 35.3 | |
| fabric C | | | | | |
| Mesh | Lace | | 25 | 44.4 | |
| material A | curtain | | | | |
| | material | | | | |
| Mesh | Super | Acetalized | 30 | 39.6 | |
| material B | | polyvinyl | | | |
| | | alcohol | | | |
| | | synthetic | | | |
| | | fibers | | | |
| Mono- | Hot-melt | Mono- | 30 | 33.6 | |
| filament | adhesive | filament | | | |
| nonwoven | sheet | fibers | | | |
| fabric | | | | | |
| Resin- | Nonslip | Foaming | 40 | 29.2 | |
| covered | sheet | vinyl | | | |
| cloth | material | chloride | | | |
| Impregnated | | Three- | 50 | 26.5 | |
| section | | dimensional | | | |
| with no | | network | | | |
| osmosis | | structure + | | | |
| membrane | | Foam | | | |
| Three- | | Three- | — | 15.7 | |
| dimensional | | dimensional | | | |
| network | | network | | | |
| structure + | | structure + | | | |
| Foam | | Foam | | | |
| (calculated | | | | | |
| values) | | | | | |
| Three- | | Three- | — | — | 10.2 |
| dimensional | | dimensional | | | |
| network | | network | | | |
| structure | | structure | | | |
| Foam | | Foam | — | — | 5.5 |

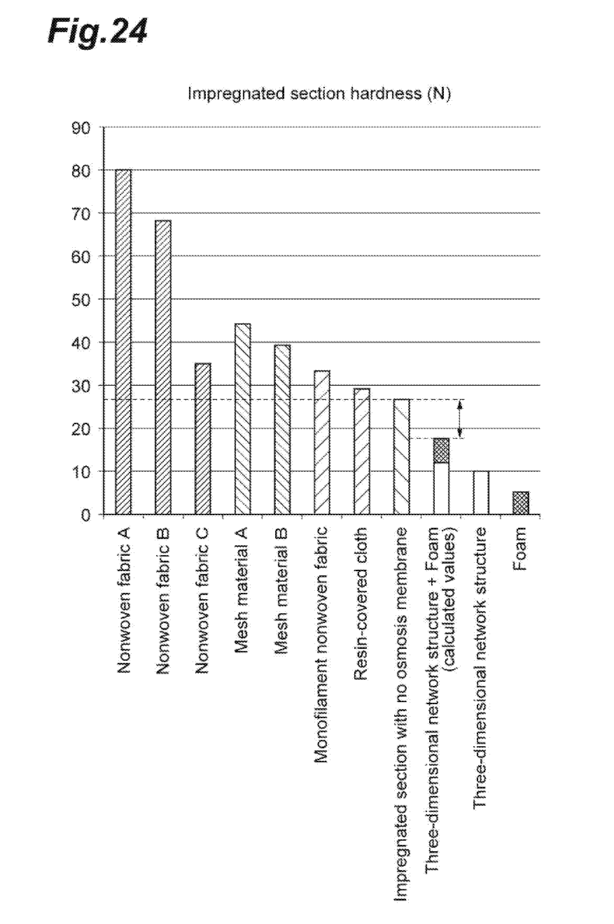

Measurement results are shown in the Table 1 and FIG. 24. As the values shown as “Impregnated section with no osmosis membrane” in the Table 1 and FIG. 24, impregnation of the three-dimensional network structure 11 with the foam material 40 without use of the osmosis membrane 21a allows the hardness of the impregnated section 51 to be higher than the sum of the hardness of the three-dimensional network structure 11 and the hardness of the foam 41. It is understood that the impregnated section 51 made of the osmosis membrane 21a indicated as “Resin-covered cloth” and the osmosis membrane 21b indicated as “Monofilament nonwoven fabric” in Table 1 and FIG. 19 has a hardness analogous to the hardness of the impregnated section 51 made of “Impregnated section with no osmosis membrane”. On the other hand, it is understood that the impregnated sections 51 made of “Nonwoven fabric A”, “Nonwoven fabric B”, “Mesh material A” and “Mesh material B” has a hardness higher than the impregnated section 51 made of “Impregnated section with no osmosis membrane”. The impregnated section 51 made of “Nonwoven fabric C” has a hardness analogous to the hardness of the impregnated section 51 made of the “Impregnated section with no osmosis membrane”, but has a tendency with a large variation in the amount of impregnation 52, with a small amount of impregnation 52 at an upper part of the impregnated section 51, and with a large amount of impregnation 52 at a lower part of the impregnated section 51.

The method of manufacturing a bonded body comprising a three-dimensional network structure and foam according to the embodiment of the present invention is not limited to the embodiments described above. It is a matter of course that various changes may be applied in a range without departing from the gist of the embodiments of the present invention.

### INDUSTRIAL APPLICABILITY

According to the method of manufacturing a bonded body comprising a three-dimensional network structure and foam in the embodiments of the present invention, the bonded body comprising the three-dimensional network structure and foam with improved connection strength can be manufactured.

### REFERENCE SIGNS LIST

11 . . . three-dimensional network structure, 12 . . . resin wire, 13 . . . adhesion point, 16 . . . low hardness section, 21a-21i osmosis membrane, 22 . . . fiber, 23 . . . resin cover, 24 . . . cavity, 25 . . . nonwoven fabric, 26 . . . monofilament fiber, 27 . . . resin film, 28 . . . pore, 29a-29e . . . slit, 29p top, 30 . . . mold, 31 . . . rib, 40 . . . foam material, 41 . . . foam, 51 . . . impregnated section, 52 . . . amount of impregnation, 61 . . . impregnation prevention membrane, 62 . . . gel material for prevention membrane, 63 . . . photo-curable solution, 64 . . . solution surface, 65 . . . nozzle, 66 . . . solution bath, 67 . . . light source, 70 . . . nozzle, 100 . . . bonded body, D direction, and L distance.

1. A method for manufacturing a bonded body comprising a three-dimensional network structure and a foam, the method comprising:
disposing the three-dimensional network structure formed by three dimensionally combining resin wires, and a foam material;
impregnating the three-dimensional network structure with the foam material; and
solidifying the foam material.

2. The method for manufacturing the bonded body comprising the three-dimensional network structure and the foam according to claim 1, further comprising:
disposing an osmosis membrane through which the foam material is permeable, on an external surface of the three-dimensional network structure, before the disposing the three-dimensional network structure and the foam material,
wherein in the impregnating the three-dimensional network structure with the foam material, the three-dimensional network structure is impregnated with the foam material through the osmosis membrane.

3. The method for manufacturing the bonded body comprising the three-dimensional network structure and the foam according to claim 2,
wherein the osmosis membrane is cloth formed of fibers, and
the fibers forming the cloth are covered with resin to prevent exposing surfaces of the fibers.

4. The method for manufacturing the bonded body comprising the three-dimensional network structure and the foam according to claim 2, wherein the osmosis membrane is nonwoven fabric formed of monofilament fibers.

5. The method for manufacturing the bonded body comprising the three-dimensional network structure and the foam according to claim 2, wherein the osmosis membrane is a resin film having any of pores or slits.

6. The method for manufacturing the bonded body comprising the three-dimensional network structure and the foam according to claim 2,
wherein the osmosis membrane is a resin film having a plurality of slits bent at respective tops, and
a pair of the slits among the plurality of the slits are bent in directions opposite to each other, and are disposed to cause the tops to face each other.

7. The method for manufacturing the bonded body comprising the three-dimensional network structure and the foam according to claim 2,
wherein the osmosis membrane is a resin film having a plurality of slits bent at respective tops, and
a pair of the slits among the plurality of the slits are bent in a same direction, and are disposed to cause the tops to be oriented in a same direction.

8. The method for manufacturing the bonded body comprising the three-dimensional network structure and the foam according to claim 1, further comprising
disposing an impregnation prevention membrane through which the foam material is impermeable, in an inside of the three-dimensional network structure, before the disposing the three-dimensional network structure and the foam material,
wherein in the impregnating the three-dimensional network structure with the foam material, a site of the three-dimensional network structure that is not configured to be impermeable by the impregnation prevention membrane is impregnated with the foam material.

9. The method for manufacturing the bonded body comprising the three-dimensional network structure and the foam according to claim 1,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

10. The method for manufacturing the bonded body comprising the three-dimensional network structure and the foam according to claim 2,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

11. The method for manufacturing the bonded body comprising the three-dimensional network structure and the foam according to claim 3,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

12. The method for manufacturing the bonded body comprising the three-dimensional network structure and the foam according to claim 4,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

13. The method for manufacturing the bonded body comprising the three-dimensional network structure and the foam according to claim 5,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

14. The method for manufacturing the bonded body comprising the three-dimensional network structure and the foam according to claim 6,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

15. The method for manufacturing the bonded body comprising the three-dimensional network structure and the foam according to claim 7,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.

16. The method for manufacturing the bonded body comprising the three-dimensional network structure and the foam according to claim 8,
wherein a part of the three-dimensional network structure includes a low hardness section having a lower hardness than portions other than the part of the three-dimensional network structure, and
in the impregnating the three-dimensional network structure with the foam material, the low hardness section is impregnated with the foam material.
